(19) United States
(12) Patent Application Publication
(10) Pub. No.: US 2015/0134458 A1
(43) Pub. Date: May 14, 2015

(54) SYSTEM AND METHOD FOR USER PROFILING

(71) Applicant: UBIQ S.R.L., PARMA (IT)

(72) Inventors: Davide Pellegrini, Parma (IT); Ivan Pastorini, Parma (IT); Mauro Amigoni, Fontanellata (IT)

(73) Assignee: UBIQ S.R.L., Parma (IT)

(21) Appl. No.: 14/415,535

(22) PCT Filed: Jul. 15, 2013
(86) PCT No.: PCT/IB2013/055825

§ 371 Date: Jan. 16, 2015

(30) Foreign Application Priority Data
Jul. 16, 2012 (IT) MI2012A001230

(51) Int. Cl. G06Q 30/02; G06K 19/06; G06K 9/32

(52) U.S. Cl. CPC G06Q 30/0269; G06Q 30/0267; G06K 9/325; G06K 19/06028
USPC 705/14.64

(57) ABSTRACT

A user profiling system, comprising: elements for acquiring an image of a receipt, related to a purchase of one or more products from a distributor, by a mobile device, which is identified by a unique identification code; elements for sending the image and the unique identification code to a unit for managing the service, the unit comprising: elements for processing the image, which extract from the image textual information comprising information identifying the one or more products at the distributor; elements for processing the textual information, which associate, for each product of the one or more products, the identification information at the distributor with information identifying the product at a manufacturer; and profile processing elements and profile storage elements, which are configured to store the information identifying the one or more products at the distributor and at the manufacturer, associated with said unique identification code of the mobile device.

The present invention lies in the field of user profiling, with particular reference to systems and methods for exchanging commercial information over data communications networks.

The need for adequate management of relations with one's own customers in order to be able to compete profitably on the market has prompted many companies to adopt systems for profiling the purchases made by said users, which make it possible to devise appropriate relational marketing policies and in particular to send to users offers of a commercial nature, such as incentives, discounts or rewards, which are personalized on the basis of the purchase habits and lifestyles of said users.

Loyalty cards are among the most widespread tools for carrying out relational marketing projects. These cards are offered to customers by a large number of commercial establishments, supermarkets and distributors in general and are the recognition and identification symbol for consumers who join a loyalty program. Such a program can comprise, for example, a point collection, with the assignment of a reward upon reaching a given threshold or the application of a percentage discount in order to give the customer an incentive to spend further.

Generally, software which makes it possible to gather, maintain and extrapolate relevant data on the purchase habits of customers is associated with a loyalty card.

However, this relational marketing system based on loyalty cards is not free from drawbacks.

Loyalty cards are in fact normally associated with a distributor of products, for example a supermarket chain, a bookstore, and so forth. This entails a double disadvantage: customers, in order to be able to take advantage of privileges and discounts, must carry with them a plurality of loyalty cards, one for each establishment or distribution chain, with evident drawbacks in terms of space occupation, inconvenience and risk of losing the cards. In addition, goods manufacturers cannot perform an overall profiling of a user, since the data are available only through the commercial establishment. Moreover, a same customer is identified in different ways by each distributor, with the consequence that the purchase habits of the customer are at the very least compartmentalized by distributor.

The aim of the present invention is to overcome the limitations of the background art described above, proposing a new system and method for the exchange of promotional information that is capable of conveying said information in a more effective and efficient manner than the background art.

Within the scope of this aim, an object of the present invention is to combine the possibility for manufacturers to reach customers directly with personalized offers that are independent of the distributors at which the customers make purchases, with the advantage for customers of receiving offers targeted on their overall purchase habits.

A further object of the present invention is to simplify the exchange of commercial offers between manufacturers and customers, utilizing the possibilities offered by modern communications technologies.

Another object of the present invention is to devise a system and a method for the exchange of promotional information that is practical and simple to use and has low implementation and management costs.

This aim and these and other objects, which will become more apparent hereinafter, are achieved by a system for sharing personal information according to claim 1.

Further characteristics and advantages of the invention will become more apparent from the following detailed description, given as a non-limiting example, accompanied by the corresponding figures, wherein:

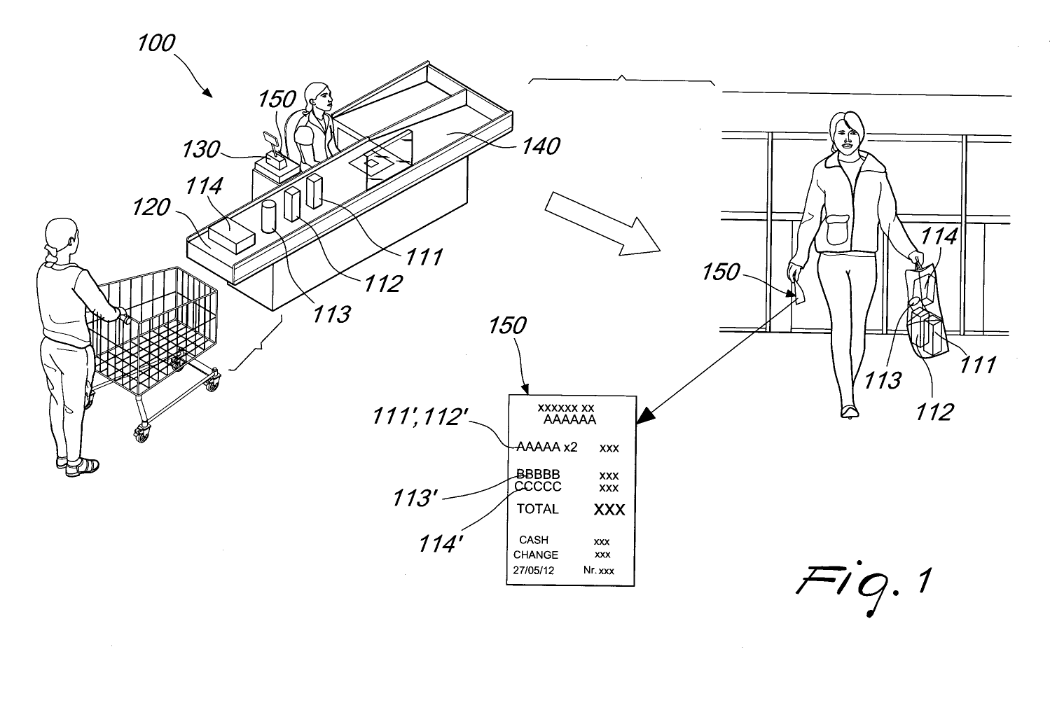

FIG. 1 is a schematic view of a generic site that allows the adoption of the system and method for the exchange of promotional information according to the present invention;

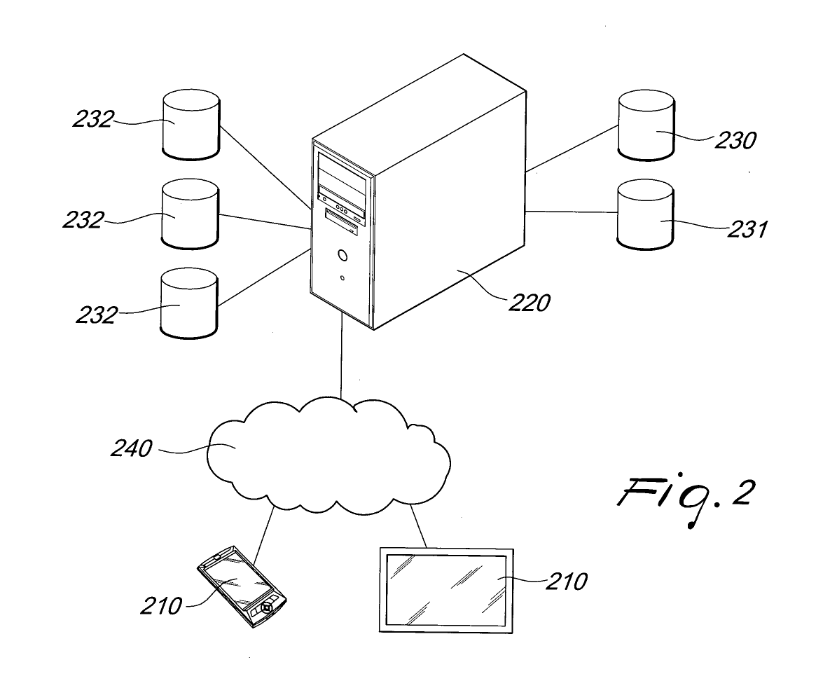

FIG. 2 is a block diagram relating to a possible architecture of the system according to the present invention;

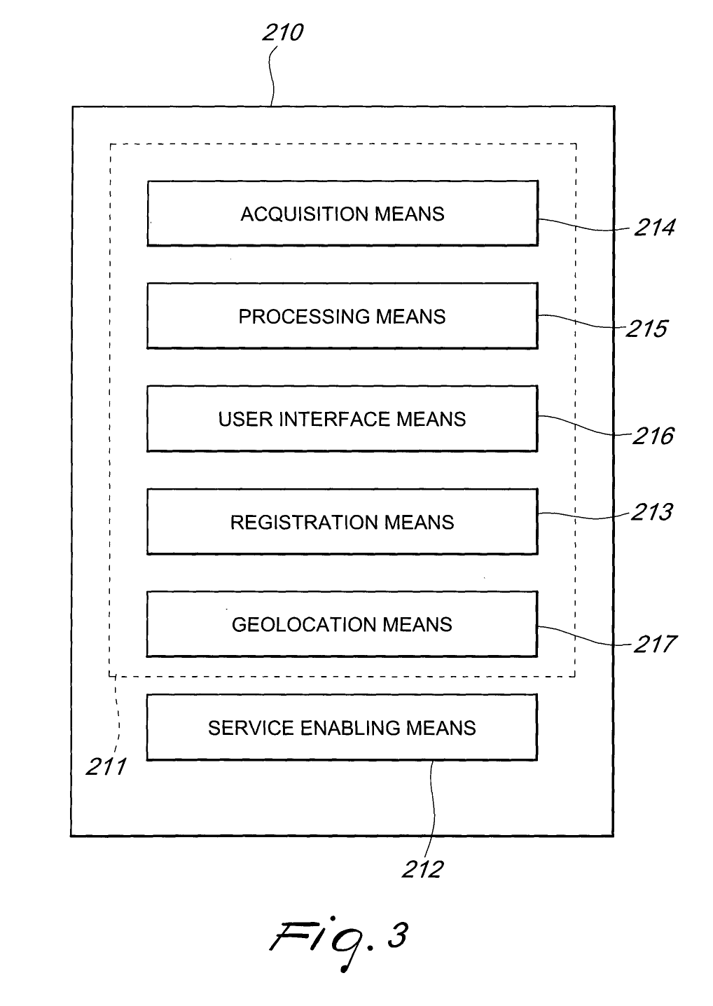

FIG. 3 is a block diagram showing in greater detail a first aspect of the architecture of FIG. 2;

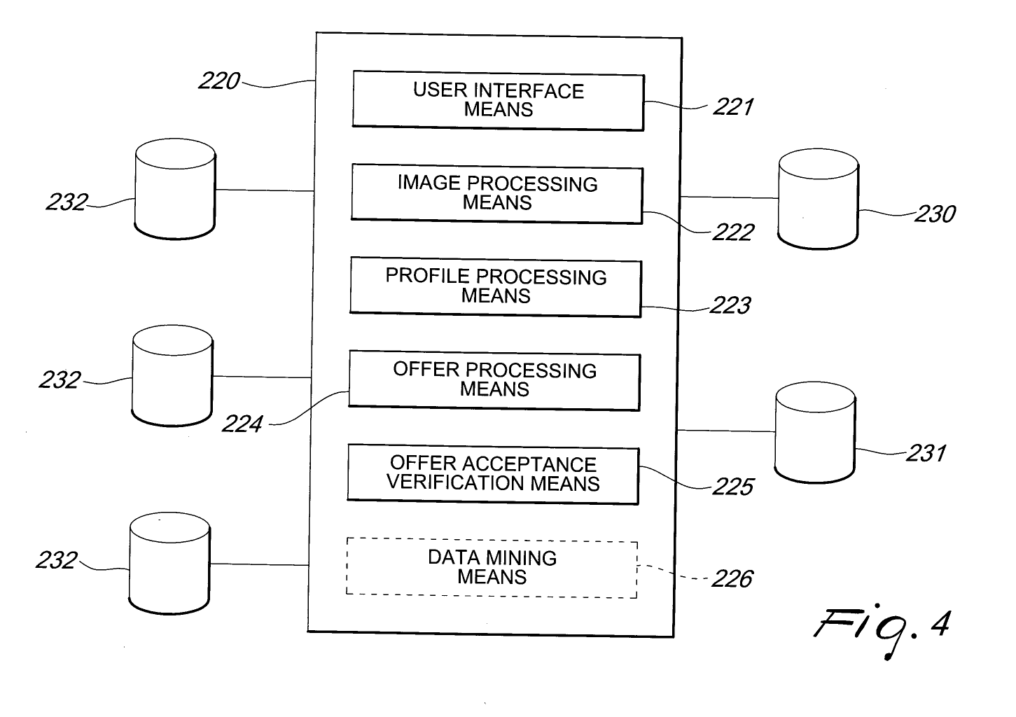

FIG. 4 is a block diagram showing in greater detail a second aspect of the architecture of FIG. 1;

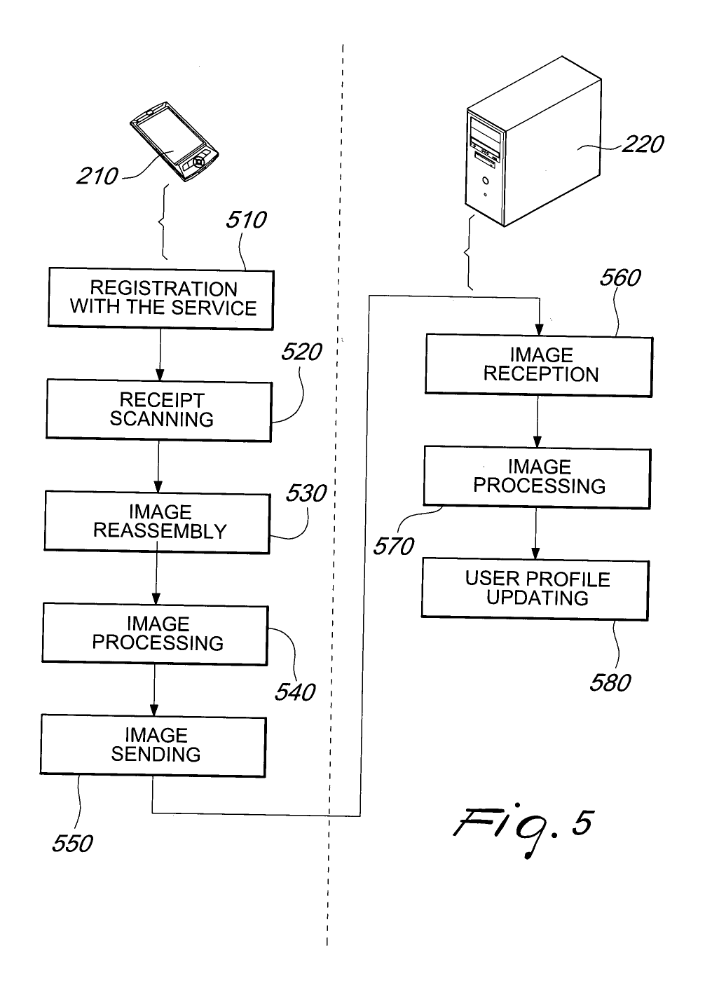

FIG. 5 is a flowchart showing a first phase of the method according the present invention;

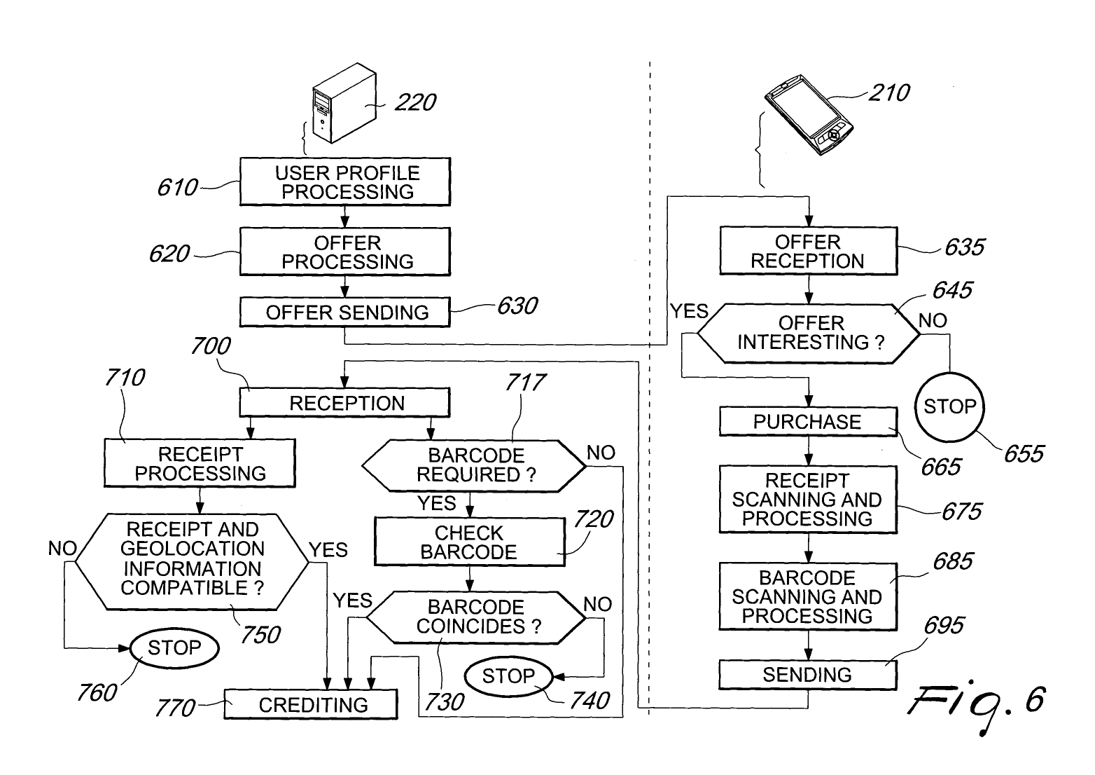

FIG. 6 is a flowchart of a second phase of the method according to the present invention.

FIG. 1 is a functional diagram of a generic commercial establishment, for example a supermarket or a shop, by means of which the user can use the system for the exchange of promotional information according to the invention.

The commercial establishment, designated by the reference numeral 100, comprises a region for access to a payment area 120 by a user 110 who has purchased one or more items 111, 112, 113, 114; a mechanical or electronic device 130 for calculating and storing the transactions related to the purchase of the items, typically a cash register; and a region for picking up the purchased items 140.

The user 110, after selecting the items 111, 112, 113, 114 that he wishes to purchase, moves toward the payment area 120 and places these items in the payment area, from where they are picked up by an operator of the cash register 130, who records the sales transaction related to each item and issues a bill for the user, i.e., a receipt 150, which bears the details of the transaction and of the payment.

The term “receipt” in this text is used to refer to any official sales document that bears the details of a purchase, for example an invoice. The user then goes to the purchased item pickup region 140, picks up the items 111, 112, 113, 114, the receipt 150 and performs the payment.

FIG. 1 is furthermore a detail view of the receipt 150, which, as is known in the art, has one or more lines for each item or type of item purchased. Each one of these lines contains descriptions and/or codes that identify said items, the total amount of the purchase and usually other data that identify the transaction, such as the date of purchase and an identifier of the commercial establishment in which the purchase occurred.

The receipt 150 is the main input data item for implementing the system and method according to the invention, as will be shown in detail with reference to the subsequent figures.

An exemplifying architecture of the system according to the present invention is summarized in the block diagram of FIG. 2.

The figure comprises a plurality of mobile devices of users of the service 210, a service management unit 220, means for storing profiles 230, means for storing vocabularies 231, means for storing products 232 and a communications network 240.

Each one of the mobile devices 210 is any device of the client type that is configured to communicate with the service management unit 220 by means of the communications network 240. In a preferred embodiment, each mobile device is a smartphone that comprises a camera and is enabled for connection to the communications network 240.

However, the mobile devices 210 are representative of any terminal provided with means suitable for sending and receiving messages of a textual and graphic type over data communications networks, including for example tablets, as will be described in greater detail with reference to FIG. 3.

The service management unit 220 is a known system of the server type, preferably a Web server, which comprises means for interfacing with the mobile devices 210 to receive images related to purchase receipts and to send promotional offers, as will be described in greater detail with reference to FIG. 4.

The service management unit 220 comprises, or has access to, a plurality of storage means 230, 231, 232, each of which can comprise for example a database or any data structure that is adapted to store information permanently. Each type of storage means will be described in greater detail with reference to FIG. 4.

The communications network 240 is preferably the Internet, connected where necessary to mobile networks for communication with the mobile devices 210.

In an alternative embodiment, the communications network 240 is any cellular network, so long as it is enabled for multimedia messaging services (MMS), for example a Universal Mobile Telecommunication System (UMTS) or any other third-generation (3G), fourth-generation (4G) or similar network.

With reference to FIG. 3, a possible architecture of the mobile devices 210 is now described in greater detail.

As is known, each mobile device 210 can be provided with a plurality of applications that make it possible to perform given functionalities, for example an application for sending and receiving text messages and/or images. The term “application” is used to refer in this context to one or more programs, routines, subroutines, function calls or other types of software or firmware and the like, used alone or in combination.

Each mobile device 210 comprises an application for communicating with the service management unit according to the invention 211 and service enabling means 212.

When a user wishes to be enabled to the service, he must first of all obtain the client application 211 that will allow him to interact with the service management unit 220; for this purpose, by interfacing with said service management unit 220, or with one of the known smartphone application providers, such as the App Store or Android Market, depending on the type of mobile device 210 that he has, he can request a download of the application according to the invention 211 onto his own mobile device 210.

The application according to the invention 211 comprises means for registering with the service 213, acquisition means 214, processing means 215, user interface means 216 and geolocation means 217.

The means for registering with the service 213 are configured to associate the mobile device 210 with a unique identifier that is adapted to allow the service management unit 220 to identify all the messages that will be sent subsequently by the application according to the invention 211 of that mobile device 210. In one embodiment, said unique identifier is the cellular number of the mobile device 210, which can be detected automatically by the means for registering with the service 213; in an alternative embodiment, the means for registering with the service 213 require the user to perform a registration procedure, which provides for entry of a username and a password by the user, optionally associated with personal data, such as personal details, purchase preferences, hobbies and so forth, according to methods that are known in the art.

The acquisition means 214 comprise a scanning device, i.e., a hardware/software device adapted to detect the receipts 150 related to the purchases made and optionally the bar codes, QR codes or the like that are present on the packages of specific purchased products, so as to generate one or more images of these objects, for purposes that will be described with reference to FIGS. 5 and 7.

In one embodiment, said acquisition means 214 comprise a camera that is present in the mobile device 210.

The processing means 215 are configured to reprocess the image or images scanned by the acquisition means 214; in particular, the processing means 215 comprise one or more among means for reassembling multiple images into a single image, in the case of receipts 150 divided over multiple images, means for increasing the quality and sharpness of the acquired images and means for converting the reassembled images into an appropriate format that is suitable for sending over a data communications network, typically a format that is lighter than that with which the images are acquired by the camera.

The user interface means 216 comprise means for sending the acquired and reprocessed images to the service management unit 220 and for receiving messages related to commercial offers that arrive from the service management unit 220, as will be described in greater detail with reference to FIGS. 5 and 6.

The user interface means 216 can furthermore comprise means for displaying the user profile and the history of purchases made and awards assigned, and means for displaying currently valid commercial offers, with a plurality of options for viewing, grouping and searching, for example by commercial category, by brand and so forth.

Finally, the mobile device 210 comprises geolocation means 217, which are configured to display graphically commercial establishments located in the vicinity of the location of the mobile device 210 and which are adapted to issue receipts 150 that can be processed by the service management unit 220. The geolocation means are furthermore configured to detect and classify the space-time coordinates of a purchase, i.e., the date, the time and the location where a given purchase, certified by a given receipt 150, was made, for purposes that will be described in greater detail with reference to FIG. 6.

FIG. 4 shows in greater detail the architecture of the service management unit according to the invention 220 of FIG. 2. The service management unit according to the invention 220 comprises means for interfacing with the users of the service 221, image processing means 222, user profile processing means 223, commercial offer processing means 224 and offer acceptance verification means 225.

The means for interfacing with the users of the service 221 comprise means for receiving images sent by the mobile devices 210, together with the identification code of the user who sent the image, and means for sending, by the service management unit 220, to the mobile devices 210 messages relating to commercial offers, as will be described in greater detail with reference to FIGS. 5 and 6.

The image processing means 222 are configured to analyze the images received from the means for interfacing with the users of the service 221 and to extract from them relevant alphanumeric information. In particular, the image processing means 222 comprise means for processing receipts and means for processing bar codes.

The receipt processing means are configured to perform optical recognition of the characters (OCR) that are present in the receipt, so as to convert the image into digital text according to methods that are known in the art.

Moreover, in order to improve the quality of the optical recognition, downstream of said recognition heuristic rules are applied which aim at recovering any errors due to poor quality of the photograph, which, despite going through preliminary processing, does not always make it possible to obtain the correct text. For example, instead of “MOZZARELLA”, the OCR recognition might return “MO22ARELLA” or “P4PER” instead of “PAPER”, and it is also possible to find letters instead of numerals in prices, for example “2.S1” instead of “2.51”. The cases are rather numerous and are caused substantially by:

particular characteristics of the characters in the receipts, which often vary among distribution chains and points of sale;

low resolution of photographs obtained from a mobile device (72 dpi) against the resolution recommended for document recognition (typically 300 dpi).

Moreover, recognition by macroregions is performed: by way of example, macroregions of interest might be the heading, to search for the chain, the point of sale and the associated address; the body, to search for products, discounts and prices, total amount; the lower part, to search for the purchase date, any auxiliary information such as loyalty card, payment type, and so forth.

The dictionary of associations between shapes and sequences of characters and their equivalent in textual format is stored in the vocabulary storage means 231, which the image processing means 222 access in order perform conversion.

In view of the particular nature of the codes, characters and lettering found in the various types of receipt, the dictionary stored in the vocabulary storage means 231 is not a standard linguistic dictionary, but a dictionary according to the invention which is calibrated on the shapes and sequences of characters that are typical of receipts.

The vocabulary can be likened to a set of rules that allow recognition of the products indicated in the receipt: by way of non-limiting example, each rule is constituted in turn by one or more elementary rules, which in turn are characterized by

one or more strings/substrings

a mode for searching for one or more strings within the lines of the receipt, in single mode (mode which can be defined by means of the “OR” logic function) or joint mode (mode which can be defined by means of the “AND” logic function)

type of search (“match”), which can be exact or performed by similarity/maximum likelihood, for example with algorithms such as “LongestCommonSubsequence”, “LevenshteinDistance”, “Double Metaphone”, “Dice coefficient”, which are known in the art, used even jointly to perform majority choices among results.

The number of elementary rules shall reflect the number of variants that can be observed in the various types of receipt in addition to rules of a general nature for trying to identify the product when faced with variants of text lines that are not known beforehand.

Example of a product present in various forms on different receipts and associated rule:

Product 1:
Biscuit XXX YYY Fiori Di Latte
Receipt 1: BISC.XX.YY FIOR D 2.48
Receipt 2: BISC.X.Y. FIORI LATTE 2.51
Rule:
<s>
<c t=“AND” s=“false”>[BISC];[XX.YY];[FIOR]</c> //variant 1
<c t=“AND” s=“false”>[BISC];[FIORI];[LATTE]</c> //variant 2
</s>

The rule considers the possibility of searching for two variants:

Variant 1: joint search (t=“AND”) and exact search (not maximum likelihood, s=“false”) of substrings “BISC”, “XX.YY” and “FIOR”.

Variant 2: joint search (t=“AND”) and exact search (not maximum likelihood, s=“false”) of substrings “BISC”, “FIORI” and “LATTE”.

Product 2:
Biscuit XXX YYY ZZZ type “Crunchy”
BISC.ZZZ CRO 1.40
Rule:
<s>
<c t=“AND” s=“false”>[BISC];[ZZ];[CRU]</c>
<c t=“AND” s=“true”>[BISC.ZZZ];[CRU]</c>
</s>

Variant 1: joint search (t=“AND”) and exact search (not maximum likelihood, s=“false”) of substrings “BISC”, “ZZ” and “CRU”.

Variant 2: joint search (t=“AND”) and maximum likelihood search (s=“true”) of substrings “BISC.ZZZ” and “CRU”.

| Product 3 (variant of a product): | |
|---|---|
| | Biscuit XXX YYY ZZZ type “Classic” |
| | BISC.ZZZ CLA 1.40 |
| <s> | //rule |

<c t=“AND” s=“false”>[BISC];[ZZ];[CLA]</c>
<c t=“AND” s=“true”>[BISC.ZZZ];[CLA]</c>
</s>

Variant 1: joint search (t=“AND”) and exact search (not maximum likelihood, s=“false”) of substrings “BISC”, “ZZ” and “CLA”.

Variant 2: joint search (t=“AND”) and maximum likelihood search (s=“true”) of substrings “BISC.ZZZ” and “CLA”.

The classification of products that are not known beforehand, or more generally not associated with a known product list, and are the subject of offers proposed to users passes through the application of a set of similar rules used to determine a potential commercial category and optionally a brand.

Moreover, correct characterization of a product occurs by evaluating also the subsequent lines that are present in the receipt, in order to deal with the splitting of information that is sometimes performed by distributors. Correct recognition of lines with auxiliary information is of primary importance in order to avoid the incorrect consideration of lines without actual information as products. For example

### ACO.NAT.SANT

12×0.39 4.68

Recognition will take into account the fact that the price of the item identified in the first line is presented in the second line (4.68).

In one embodiment, the vocabulary storage means 231 return in particular information in a textual format that comprises information related to the distributor where the receipt was acquired and, for each purchased product, a product identification code, in which the characteristic coding is variable for each distributor.

The barcode processing means are configured to scan and decode the images of barcodes in order to return the information contained therein, typically the code of a product, according to methods known in the art.

The means for processing user profiles 223 are configured to acquire from the user interface means 221 the identification code of the user who sent the images and to acquire from the image processing means 222, particularly from the receipt processing means, the digital text that is the result of the conversion of the image of the receipt 150 sent by the user. The user profile processing means 223 are furthermore configured to process, combine and encode this information so that it can be stored conveniently in the profile storage means 230; in one embodiment, a record related to the purchase transaction is stored which comprises for example the user identification code, the date of purchase, the distributor at which the purchase was made and the total amount of the purchase; a plurality of records, associated with the record related to the transaction by means of an appropriate key, is also stored for each type of purchased item, each record comprising for example the code of the purchased item, the quantity of purchased items and the purchase price. Each purchased item code comprises an identification code of said item in the coding of the specific distributor, as returned by the vocabulary storage means 231, and, associated therewith, a code that corresponds to it as stored in the product storage means 232. In this manner, each purchased item can be identified by a unique product code that is independent of the distributor at which it was purchased, i.e., the code of the product as coded by the manufacturer and stored in the product storage means 232.

For this purpose, the product storage means 232 comprise, for each distributor at which the product is distributed, a record which associates a distributor identification code, the coding of the product by the distributor and the coding of the product by the manufacturer.

In one embodiment of the invention, the means for processing bar codes allow the classification of products that are not known beforehand, or more generally are not associated with a known product list, and are optionally the subject of offers proposed to users.

When the receipt shows an unknown distributor product coding which therefore is not comprised in the vocabulary storage means 231, the system asks the user to scan the corresponding barcode (i.e., the unique product code coded by the manufacturer) and to send said scan to the service management unit 220. The user interface means 221 receive the sent scan and forward it to the image processing means 222, in particular to the barcode processing means. These means decode the received bar code image, thus allowing the service management unit 220 to associate the distributor product coding, previously unknown, now stored in the vocabulary storage means 231, with the unique product code coded by the manufacturer that is the result of the decoding of the barcode, stored in the product storage means 232.

The product storage means 232 can comprise a distinct database for each manufacturer, which can be alternatively operated by the service management unit 220 or directly by the manufacturer and to which the service management unit 220 has access through remote management systems that are known in the art. In an alternative embodiment, the product storage means 232 comprise a single database that stores all the products of all the manufacturers that participate in the service.

The person skilled in the art shall understand without effort that although for the sake of clarity in description the storage means 230, 231 and 232 have been shown as distinct storage means they can alternatively be unified into a single appropriately structured database.

The commercial offer processing means 224 are configured to access the profile storage means 230 and to process, on the basis of the history of the purchases made by a user and of appropriate business rules that are coded in said commercial offer processing means 224 and can be configured by the operator of the service management unit 220, a commercial offer that is personalized so as to be potentially of interest to said user. By way of non-limiting example, the commercial offer might relate to an incentive to purchase a product that the user had purchased periodically in the past and that in recent transactions is no longer included among purchases, or an incentive to purchase in a greater quantity an item that is purchased regularly, or an incentive to purchase a product that has never been purchased but, on the basis of the purchase habits of the user that can be deduced from his profile, might be of interest to the user, or an incentive to try a new product sponsored by one of the manufacturers that participate in the service, and so forth.

The incentive to purchase can be formulated according to a plurality of modes, for example a discount applied to the purchased product, a formula of the “buy 3, pay for 2” type, a gadget associated with the purchase of a product.

Once the commercial offer has been devised, the offer processing means 224 report its relevant information to the user interface means 221, so that they send the commercial offer to the mobile device 210 of the user, who can display it in the application according to the invention 211.

The processed offer, which comprises the code of the product to which the offer relates and other relevant information, is stored furthermore in the profile storage means 2030, so that at a later time it is possible to verify whether the offer has been accepted or not.

The offer acceptance verification means 2025 are configured to acquire from the user interface means 221 the identification code of the user who sent the barcode related to the item for which the user previously received a commercial offer and to acquire from the image processing means 222, particularly from the barcode processing means, the decoded information related to said barcode, i.e., the code of the product. The offer acceptance verification means 225 are furthermore configured to verify, by accessing the record related to the commercial offer stored previously in the profile storage means 230, whether the product purchased by the user coincides with the product to which the offer related; in one embodiment, this verification is performed by comparing the code of the product decoded starting from the barcode with the product code stored in the record related to the commercial offer. The offer acceptance verification means 225 furthermore comprise means for crediting the user, which are configured to credit the user, if said verification has a positive outcome, with the sum agreed upon on the basis of the commercial offer. The credit can occur according to a plurality of modes, for example crediting to the telephone credit of the customer, crediting to a credit card or current account if these have been entered in the user profile, sending a voucher in digital or paper format, and so forth.

The service management unit 220 can optionally comprise data mining means 226, configured to access the profile storage means 230 and to process the information stored according to methods that are known in the art in order to generate data extractions, statistics or analyses for optional exporting to manufacturer customers.

The operation of the system provides for two distinct phases: a data acquisition phase, for user profiling, and a commercial offer processing step, as described hereinafter with reference to FIGS. 5 and 6.

With reference to the flowchart of FIG. 5, a possible embodiment of a data acquisition method for user profiling according to the invention is now described.

The method begins in step 510, in which a user who wishes to use the service registers with said service by means of his own mobile device 210; as previously mentioned, registration occurs by downloading onto the mobile device 210 the client application according to the invention 211 and by providing, by virtue of the service registration means 213, a unique identification code that is stored in the application according to the invention 211 with the methods already described with reference to FIG. 3.

Once registration has been performed, the user is enabled to use the service every time he receives a receipt 150 that he wishes to send to the service management unit 220.

In particular, in step 520 the user, by using the client application according to the invention 211 and in particular the user interface means 221, scans the receipt 150, optionally performing multiple scans if the receipt is too long to be processed in a single scan.

In step 530, the processing means 215 perform, if necessary, the reassembly of the plurality of scanned images into a single image that comprises the entire receipt; in step 540, the processing means 215 adopt appropriate methods for enhancing the reassembled image, in order to increase its quality and sharpness and reduce the size of the corresponding file.

The operations for pre-processing the image described with reference to the above-cited steps 530 and 540 are performed advantageously on the mobile device 210, so as to allow the user to perform a “human” verification of the result of any reassembly and reprocessing of the scanned images and so as to allow said user to give his consent to the subsequent sending of the single image that comprises the entire receipt.

In step 550, the user interface means 216 send the reassembled and processed image to the service management unit 220, together with the identification code of the user of the service.

In step 560, the service management unit 220, in particular the means for interfacing with the users of the service 221, acquire the data sent by the mobile device 210, which comprise the image of the receipt 150 and the identification code of the user.

In step 570, the image processing means 222 perform optical recognition of the characters contained in the image of the receipt 150 and return the digitized text to the user profile processing means 223.

Finally, in step 580 the user profile processing means 223 process the digitized text received in step 570 in order to extract one or more records related to the purchase transaction, associate with each record information related to the article, respectively according to the distributor and manufacturer codings, and update the user profile storage means 230 accordingly, as already shown with reference to FIG. 4.

In a different embodiment, the operations for reassembling the plurality of scanned images, described earlier, are not performed in step 530 by the processing means 215 of the mobile device 210 but are performed in step 570 by the receipt processing means 222 of the service management unit 220.

In this embodiment, said receipt processing means are configured both to perform optical recognition of the characters (OCR) that are present in the receipt and to reassemble the plurality of scanned images into a single image that comprises the entire receipt, so as to be able to crop and/or pair texts that can overlap and are present in more than one scanned image and so as to be able to perform said croppings and/or pairings while checking that the sum of the prices of the products that are listed on the resulting complete receipt is equal to the total of said receipt.

The reassembly of the plurality of scanned images into a single image comprising the entire receipt, performed with the embodiment described above, might appear for example as follows:

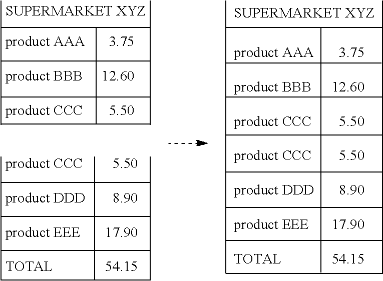

In a further embodiment of the present invention, the operations for reassembling the plurality of scanned images are performed by the mobile device 210 in step 530, since the processing means 215 are configured also to perform optical recognition of the characters (OCR) that are present on the receipt, thus being able to perform the same cropping and/or pairing operations described in the previously described embodiment.

With reference to the flowchart of FIG. 6, a possible embodiment of a method for processing and accepting a commercial offer according to the invention is now described.

The method begins in step 610, in which the service management unit 220, in particular the commercial offer processing means 224, access the profile storage means 230 and extract data related to the history of the purchases made by a user.

In step 620, the commercial offer processing means 224 process, on the basis of said purchase history and of appropriate business rules coded in said commercial offer processing means 224, a commercial offer that is personalized so as to be potentially of interest to the user, as already described with reference to FIG. 4.

The person skilled in the art shall understand without effort that although for the sake of convenience in description the method is described as being performed sequentially for each individual user, the processing of user profiles and of the corresponding commercial offers might occur in parallel for a plurality of users.

In step 630, the means for interfacing with the users of the service 221 send the commercial offer processed in step 620 to the mobile device 210 of the user.

In step 635, the user of the mobile device 235 visualizes in the application according to the invention 211, particularly in the user interface means 216, the commercial offer processed in step 620. The received offer is stored in the application according to the invention 211, and the user can decide whether to accept or refuse it and whether to do so immediately or at a later time.

In step 645, the user of the mobile device 210 decides whether the commercial offer received in step 635 is of interest to him. If it is not, the method ends with step 655.

If in step 645 the user decides to accept the commercial offer, in step 665 he purchases the product indicated by said commercial offer, optionally together with the purchase of other products; then, in step 675, with the aid of the mobile device 210, he scans and processes the receipt 150 in ways that are similar to the ones described with reference to steps 520, 530 and 540.

In step 680, the user verifies whether the specifications of the purchase offer indicate that it is necessary to send, in order to certify the purchase, also the barcode of the product to which the offer relates. Sending the barcode is necessary typically in the case of products that cannot be completely identified, for example because they are recognizable in their shape or flavor only by means of the codes given in the receipt.

If in step 680 the user verifies that the sending of a barcode is required, in step 685 the user performs an operation that is similar to the one performed in step 675: in this case, however, the scan relates to the barcode of the product to which the commercial offer referred.

In step 695, the user interface means 116 send the image of the receipt and optionally the image of the barcode to the service management unit 220; the identification code of the user of the service and geolocation information related to the date, time and location where the scan of the receipt was made are also sent together with these images. In this manner, the user sends the elements that are necessary and sufficient to certify that he has actually purchased the product to which the promotion referred.

In step 700, the service management unit 220, in particular the means for interfacing with the users of the service 221, receive the images and data sent by the mobile device 210 in step 695, i.e., the image of the receipt 150 scanned in step 675, the optional image of the barcode scanned in step 685, and the geolocation information related to the time and location of the purchase, together with the user identification code.

In step 710, the service management unit 220 performs the acquisition, optical recognition and storage of the data of the receipt 150 in the profile storage means 230 in ways that are similar to the ones shown with reference to steps 570 and 580.

In step 717, the offer acceptance verification means 225 verify whether the image of a barcode has also been sent together with the image of the receipt; if so, in step 720 the offer acceptance verification means 225 acquire from the user interface means 221 the identification code of the user who sent the barcode and acquire from the image processing means 222, particularly from the barcode processing means, the decoded information related to said barcode, i.e., the code of the product to which the commercial offer referred. On the basis of these data, the offer acceptance verification means 225 check whether the product purchased by the user coincides with the product to which the commercial offer relates, in ways that have already been described with reference to FIG. 4.

If in step 730 the offer acceptance verification means 225 determine that the purchased product does not coincide with the offered one, in step 740 the method ends.

In step 750, the offer acceptance verification means 225 check whether the geolocation information received, relating to the date, time and location where the receipt was scanned and collected previously by the geolocation means 217, are compatible with those that can be deduced from the receipt 150 analyzed in step 710; if this verification has a negative outcome, in step 760 the method ends.

This step is particularly advantageous in the case of products offered at promotional prices only in given periods of time and/or exclusively in a specific geographical area, since it allows the service management unit 220 to verify, with a double check (information from the receipt and geolocation information), that the product was actually purchased in the period of time and/or in the town, region or more generally geographical area in which said product is being promoted.

If both verifications according to steps 730 and 750 have a positive outcome (or if the verification according to step 717 has a negative outcome and the verification of step 750 has a positive outcome), in step 770 the offer acceptance verification means 225 credit the sum agreed upon in the commercial offer in ways already described with reference to FIG. 4.

It has thus been shown that the described method and system achieve the intended aim and objects. In particular, it has been shown that the system thus conceived allows overcoming the qualitative limitations of the background art thanks to the fact that it allows conveying commercial offers directly from manufacturers to customers without the filter of distribution, with evident advantages both in economic terms and in terms of practicality.

Thanks to the method and the system according to the invention, moreover, manufacturers can know the purchase habits of their customers more deeply, because the purchase history is no longer split among a plurality of distributors and because customers are given an incentive to take part actively in the process for acquisition of profiling data.

The method and the system according to the invention are advantageous also for users, who can take advantage of commercial offers by means of a single application without the need of having a different loyalty card for each commercial establishment.

Obviously, numerous modifications are evident and can be performed promptly by the person skilled in the art without abandoning the protective scope of the present invention. For example, although the invention has been described with reference to mobile devices, it is evident to the person skilled in the art that the invention can also be provided by adopting, instead of a mobile device, an ordinary personal computer, so long as it is provided to with an Internet connection and with image acquisition means.

Furthermore, although the invention has been described with reference to supermarkets, it applies likewise to any kind of commercial establishment, for example bars, pharmacies or any retailer in which purchase is certified.

It is furthermore possible to conceive use of the invention to profile purchases performed not by end users but by establishment operators, for example a bar or shop: when the operator resupplies by means of a wholesale dealer and receives an invoice for the purchase made, he can scan the invoice, which is processed in ways similar to the ones described for receipts.

Therefore, the protective scope of the claims need not be limited by the illustrations or preferred embodiments shown in the description by way of example, but rather the claims must comprise all the characteristics of patentable novelty that reside within the present invention, including all the characteristics that would be treated as equivalent by the person skilled in the art.

The disclosures in Italian Patent Application no. MI2012A001230, from which this application claims priority, are incorporated herein by reference.

Where technical features mentioned in any claim are followed by reference signs, those reference signs have been included for the sole purpose of increasing the intelligibility of the claims and accordingly such reference signs do not have any limiting effect on the interpretation of each element identified by way of example by such reference signs.

1-10. (canceled)

11. A user profiling system, comprising:
means for acquiring an image of a receipt, related to a purchase of one or more products from a distributor, by a mobile device, said mobile device being identified by a unique identification code;
means for sending said image and said unique identification code to a unit for managing the service, said service management unit comprising:
means for processing said image, which are configured to extract from said image textual information comprising information identifying said one or more products at said distributor,
means for processing said textual information, which are configured to associate, for each product of said one or more products, said identification information at said distributor with information identifying the product at a manufacturer; and
profile processing means and profile storage means, which are configured to store said information identifying said one or more products at said distributor and at said manufacturer, associated with said unique identification code of said mobile device.

12. The system according to claim 11, wherein said service management unit further comprises:
means for processing commercial offers, which are configured to access said profile storage means in order to extract the purchase history of said mobile device and to process, on the basis of said purchase history, a commercial offer which comprises one or more products to be sent to said mobile device; and
means for sending said commercial offer to said mobile device.

13. The system according to claim 12, wherein said mobile device further comprises:
user interface means, which are configured to display said commercial offer sent by said service management unit;
geolocation means configured to detect the space-time coordinates at which a purchase certified by said receipt was made; and
means for sending said space-time coordinates and said unique identification code to said service management unit.

14. The system according to claim 13, wherein said mobile device further comprises means for acquiring an image of one or more bar codes, said barcodes being related to products of said commercial offer, said sending means being further configured to send said image of said one or more barcodes together with said space-time coordinates and said unique identification code to said service management unit.

15. The system according to claim 14, wherein said service management unit further comprises:
means for processing said image of one or more barcodes, which are configured to decode said one or more barcodes in order to extract one or more codes of products associated with said one or more bar codes;
means for verifying the acceptance of offers, which are configured to verify, on the basis of said one or more product codes, whether said one or more product codes coincide with said one or more products of said commercial offer, and to verify whether said space-time coordinates are compatible with space-time information detectable from said receipt; and
crediting means, configured to credit to the user of said mobile device the sum agreed upon on the basis of said commercial offer, if the verification of the preceding step has yielded a positive outcome.

16. A user profiling method, comprising the steps of:
acquiring, by acquisition means of a mobile device, an image of a receipt related to a purchase of one or more products from a distributor, said mobile device being identified by a unique identification code;
sending, by sending means of a mobile device, said image and said unique identification code to a service management unit;
extracting from said image, by first processing means of said service management unit, textual information comprising information identifying said one or more products at said distributor;
associating, by second processing means of said service management unit, said information identifying said one or more products at said distributor with information identifying said one or more products at a manufacturer; and
storing, by profile processing means and profile storage means (230), said information identifying said one or more products at said distributor and at said manufacturer, associated with said unique identification code of said mobile device.

17. The method according to claim 16, further comprising the steps of:
accessing, by commercial offer processing means of said service management unit, said profile storage means and extracting a purchase history of said mobile device;
processing, by said commercial offer processing means of said service management uni, on the basis of said purchase history, a commercial offer to be sent to said mobile device; and
sending, by means for sending said commercial offer of said service management unit, said commercial offer to said mobile device.

18. The method according to claim 17, further comprising the steps of:
displaying, by user interface means of said mobile device, said commercial offer sent by said service management unit;
detecting, by geolocation means, the space-time coordinates at which a purchase certified by said receipt was made; and
sending, by sending means of said mobile device, said space-time coordinates and said unique identification code to said service management unit.

19. The method according to claim 18, further comprising the steps of:
acquiring, by means for acquiring an image of one or more bar codes of said mobile device, an image of one or more bar codes, said one or more bar codes being related to products of said commercial offer; and
sending, by said sending means of said mobile device, said image of said one or more bar codes together with said space-time coordinates and said unique identification code to said service management unit.

20. The method according to claim 19, further comprising the steps of:
processing, by means for processing said image of one or more barcodes of said service management unit, said image of one or more barcodes in order to decode said one or more barcodes and extract one or more codes of products associated with said one or more barcodes;
verifying, by offer acceptance verification means of said service management unit, on the basis of said one or more product codes, whether said one or more product codes coincide with said one or more products of said commercial offer and verifying whether said space-time coordinates are compatible with space-time information that can be acquired from said receipt; and
crediting, by crediting means of said service management unit, to the user of said mobile device the agreed sum on the basis of said commercial offer, if the verification according to the preceding step has yielded a positive outcome.
